(19) United States
(12) Patent Application Publication
(10) Pub. No.: US 2016/0198233 A1
(43) Pub. Date: Jul. 7, 2016

(54) LOCAL MESSAGE PERFORMANCE ON AN ENTERTAINMENT SYSTEM

(71) Applicant: AMI Entertainment Network, LLC, Trevose, PA (US)

(72) Inventor: Howard L. SPIELMAN, Placerville, CA (US)

(21) Appl. No.: 15/066,788

(22) Filed: Mar. 10, 2016

Related U.S. Application Data
(63) Continuation of application No. 11/741,153, filed on Apr. 27, 2007.

(51) Int. Cl. H04N 21/488; H04N 7/16; H04N 21/2543

(52) U.S. Cl. CPC H04N 21/4882; H04N 21/2543; H04N 7/163

(57) ABSTRACT

Systems and methods are provided for enabling users to locally request the presentation of messages on an entertainment system. In particular, a method of operating an entertainment system is provided, including: receiving a request to perform a local message for performance in a single venue; and performing a series of messages, said series of messages comprising network messages for performance in on a plurality of entertainment systems and the local message.

### CROSS-REFERENCE TO RELATED APPLICATIONS

This application is a continuation of U.S. patent application Ser. No. 11/741,153, filed on Apr. 27, 2007, currently pending, entitled “Local Message Performance on an Entertainment System”, the entire contents of which are incorporated by reference herein.

### BACKGROUND OF THE INVENTION

Traditional entertainment systems for out-of-home use, for example in restaurants or bars, are typified by the jukebox that plays selected vinyl records or compact discs after the insertion of coins or paper currency.

More recently, entertainment systems for public venues have begun to provide additional forms of entertainment beyond merely playing music from compact discs. Some entertainment systems are provided with personal computer architecture and are equipped with hard drives capable of storing huge libraries of music, video, and games. Patrons of the venue may operate the entertainment system to provide the desired service, such as to play a selected song or display a selected music video. Such patrons who operate the entertainment system are hereinafter referred to as the “users”.

These entertainment systems may include video display devices for providing information regarding entertainment content currently being performed. For example, in CD-based jukeboxes, a CD identification number and track number for the currently playing song may be displayed on a digital LED display. More contemporary jukeboxes have been provided with video monitors that are capable of displaying rich text and graphics. These video display devices can present a graphical user interface for enabling the user to browse the catalog of available entertainment content, enter their selections, and view detailed information regarding the content being performed (e.g., album, artist, and song title for music selections, or title and actors for video selections).

Because modern jukeboxes and digital entertainment systems have the ability to provide a sophisticated user interface and to display graphics on a video screen, it would be desirable to utilize these capabilities to provide additional services for improving the user's experience and to increase revenue.

### BRIEF SUMMARY OF THE INVENTION

Systems and methods are provided for enabling users to locally request the presentation of messages on an entertainment system. In accordance with embodiments of the present invention, a method of operating an entertainment system is provided, comprising: receiving a request to perform a local message for performance in a single venue; and performing a series of messages, said series of messages comprising network messages for performance in on a plurality of entertainment systems and the local message.

In accordance with other embodiments, an entertainment system is provided, comprising: a network interface for coupling the entertainment system with a host system over a network; a video display device for displaying graphical content to a user; a user input device; and a control module configured to: receive a request to perform a local message for performance in a single venue; and perform a series of messages, said series of messages comprising network messages for performance in on a plurality of entertainment systems and the local message.

In accordance with other embodiments, a method of operating an entertainment system is provided, comprising: receiving from the entertainment system a report of local message purchases on the entertainment system; determining a local message revenue based on the report of local messages; and distributing to the operator of the entertainment system a portion of the determined local message revenue.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### BRIEF DESCRIPTION OF THE SEVERAL VIEWS OF THE DRAWINGS

FIG. 1 shows a simplified block diagram of an exemplary entertainment system, in accordance with embodiments of the present invention.

FIG. 2 is a simplified block diagram of an entertainment network, in accordance with embodiments of the present invention.

FIG. 3 shows a simplified block diagram of a host system, in accordance with embodiments of the present invention.

FIG. 4 shows a simplified block diagram of an entertainment system, in accordance with embodiments of the present invention.

FIG. 5 shows a flowchart of a method of operating an entertainment system.

FIG. 6 shows a screenshot prompting a user to request performance of a local message.

FIG. 7 shows a screenshot of an exemplary touch screen interface for entering a local message.

FIGS. 8A-8B show exemplary screenshots of the performance of local messages.

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description which follows are presented in terms of procedures, steps, logic blocks, processing, and other symbolic representations of operations on data bits that can be performed on computer memory. Each step may be performed by hardware, software, firmware, or combinations thereof.

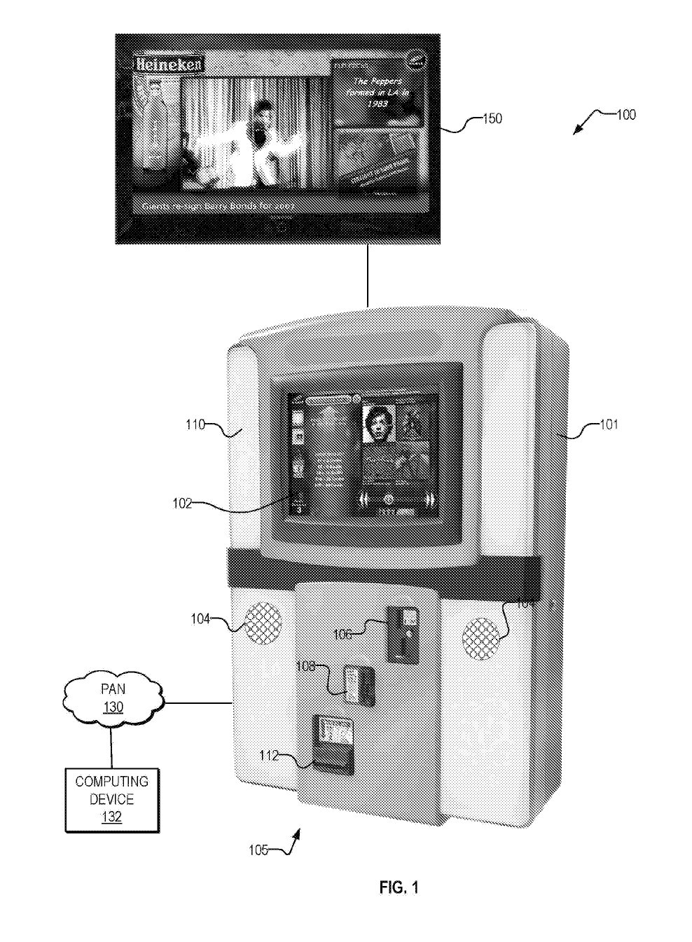

FIG. 1 is a perspective view of an exemplary entertainment system 100, in accordance with embodiments of the present invention. This entertainment system 100 comprises a primary entertainment device 101 and an external display device 150. The primary entertainment device 101 comprises a housing 110 including an opening for a touch-screen video display device 102. The entertainment device 101 also optionally includes at least one audio speaker 104 and a payment interface 105. In the illustrated embodiment, the payment interface 105 comprises a cash payment collector and a non-cash payment collector. The cash payment collector comprises a coin collector 106 and a bill collector 112 for receiving cash payments from users in the form of coins, tokens, or bills. The non-cash payment collector comprises a card reader 108 for accepting payments from users using a credit card, debit card, smart card, magnetic strip token card, or other non-cash forms of payment.

In other embodiments, one or more of the payment collectors 106, 108, 112 may be omitted and/or other types of payment collectors may be added. For example, in some embodiments, the entertainment system may offer free selection of content to users, with payment made via a periodic lease, license, or subscription fee for the system, e.g., paid by the venue proprietor. In other embodiments, a user may log into the entertainment system 100 using a User ID. This User ID may be associated with prepaid credits or with a credit card for automatic debits in exchange for performance of entertainment content on the entertainment system 100.

The entertainment device 101 also includes audio and/or video outputs for transmitting audio and/or video signals for performance by external devices, such as loudspeakers and video display devices (e.g., external flat screen display 150) provided elsewhere in the venue, to replace or supplement the speakers 104 and display device 102.

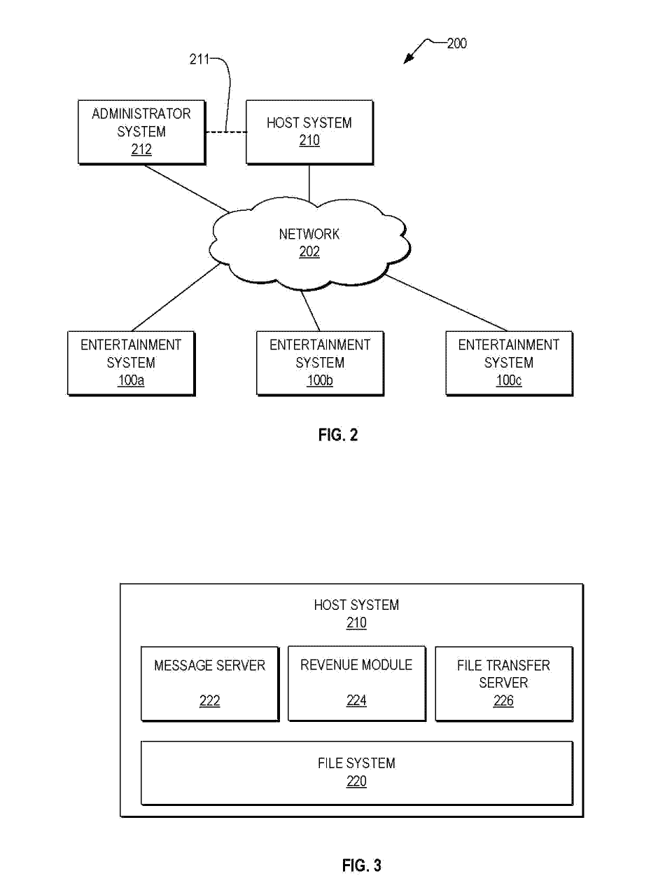

FIG. 2 shows a simplified block diagram of an entertainment network 200, in accordance with embodiments of the present invention. The entertainment network 200 comprises a host system 210 coupled to a plurality of entertainment systems 100a-100c over a network 202. The network 202 may comprise, e.g., a wide-area network (WAN), such as the Internet. The host system 210 and the entertainment systems 100a-100c may connect to the network 202 via various mechanisms, as would be understood by those of ordinary skill in the art. For example, the systems may have broadband connections to the Internet, and may be continuously or intermittently coupled to the network 202. Each of the entertainment systems 100a-100c may be located in a public venue, such as a bar, restaurant, or arcade.

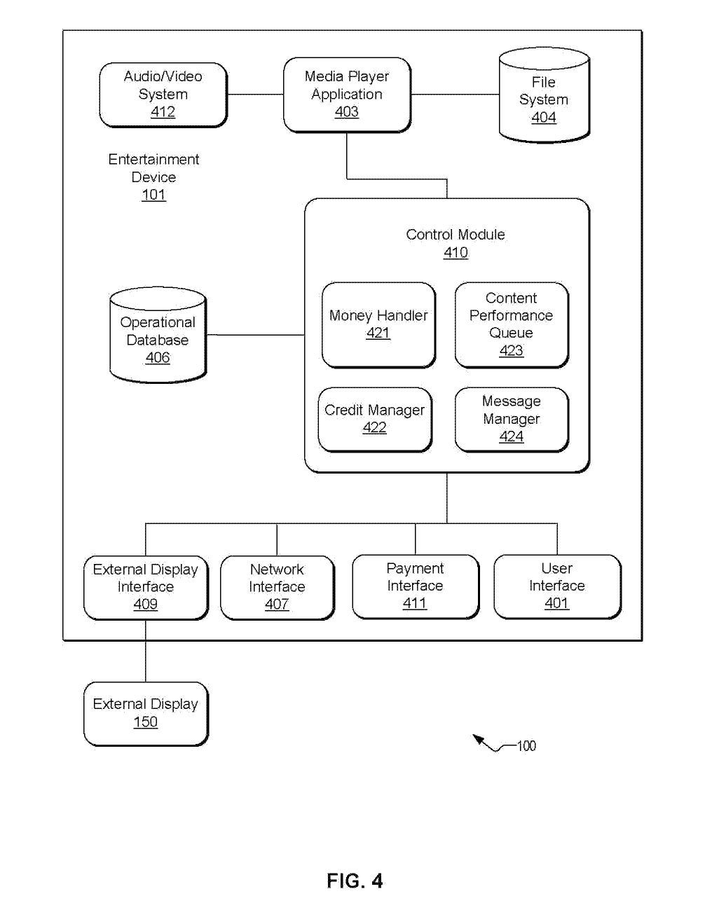

The host system 210 may comprise a central management system for controlling the various entertainment systems 100, for distributing entertainment and advertising content, such as music, video, graphics, interactive surveys and quizzes, or text files, and operational content, such as software updates, to those systems 100, and for receiving performance information from the entertainment systems 100. This host system 210 may take various forms, one example of which is shown in FIG. 3.

The host system 210 shown in FIG. 3 comprises multiple components which may be implemented on a single server or across multiple servers. The illustrated host system 210 is a simplified block diagram of an exemplary host system with various components omitted for clarity, and in other embodiments, the host system 210 may be configured differently. As shown, the host system 210 comprises one or more message servers 222 which can transmit and receive messages to and from the entertainment systems 100 coupled to the network 202.

A file system 220 is provided for storing various files that may be downloaded by the entertainment systems 110. The file system 220 may comprise, e.g., a storage subsystem containing operational files, such as, e.g., software patches, executable programs, graphic files for use in the entertainment system's user interface, configuration setting files, or other files that may be used to control the operation of the entertainment system 110. The file system 220 may further contain advertising and entertainment content files such as, e.g., digital audio files, multimedia files, text files, game files, and other files that may be performed for or accessed by users at the venue location. The file system 220 may further store metadata associated with the entertainment content, such as, e.g., title, artist, and album information corresponding to each musical song file.

One or more file transfer servers 226 may be provided for managing the transfer of files from the file system 220 to the various entertainment systems 100. Each of the files stored in the file system 220 may be associated with a unique Content ID to enable entertainment systems 100 to easily identify and retrieve files from the file system 220.

The host system 210 may further comprise a revenue module 224. The revenue module 224 manages the payments that are received from users of the entertainment systems 100 and from advertisers who provide payment in exchange for the performance of commercial advertisements on one or more of the entertainment system 100a-100c.

The operation of a similar entertainment network is described in U.S. patent application Ser. No. 10/956,823, entitled “Prioritized Content Download for an Entertainment system”, filed on Oct. 1, 2004, and published as U.S. publication no. 2006-0074750 A1, the contents of which are incorporated by reference herein in its entirety.

An administrator may manage the host system 210 directly or may use a separate administrator system 212 to interface with and control the host system 210. The administrator system 212 may comprise a separate computer system couplable to the host system 210 via a wide-area network (WAN), such as the network 202, or via a local-area network (LAN) 211.

The entertainment system 100 may comprise any of a variety of network-enabled entertainment systems, such as, e.g., freestanding jukeboxes, wall mounted jukeboxes, countertop units, and dedicated gaming units. These entertainment systems 100 may provide users with entertainment content in various forms, such as, e.g., audio, video, graphics, video games, software, text, and combinations thereof.

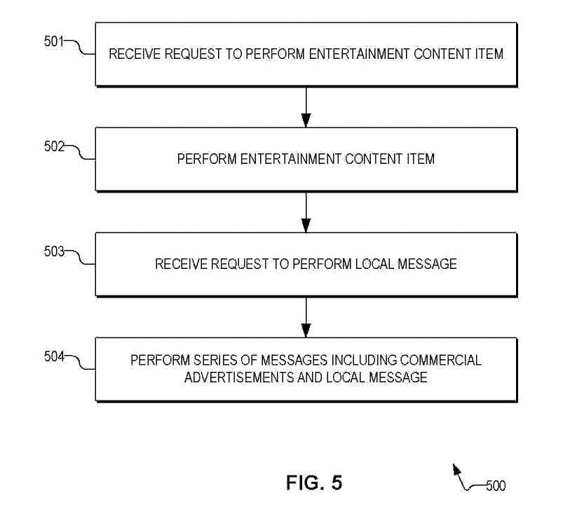

FIG. 4 is a simplified block diagram of an exemplary jukebox-type entertainment system 100. The entertainment system 100 may take various forms, but in the illustrated embodiment comprises an entertainment device 101 having a user interface 401, which may comprise a user input device enabling a user at the venue where the entertainment system 100 is located to input commands into the entertainment system 100. The user interface 401 may comprise, e.g., a keyboard, a touchpad, a mouse, a touch-screen display, and/or other input device, as would be understood by those of ordinary skill in the art. In the embodiment illustrated in FIG. 1, the user input device comprises a touch-screen display 102. In many cases, for ease of use, the entertainment system 100 will not be provided with a keyboard or mouse, such that the only user interface device is the touch-screen display.

The entertainment system 100 also comprises an audio/video system 412, which enables the entertainment system 100 to perform entertainment content, e.g., in response to user requests, on a periodic basis (such as every ten minutes if there are no user requests pending), or according to a predetermined schedule. The audio/video system 412 may comprise an amplifier and audio speakers (e.g., speakers 104) for playing music and a monitor (e.g., display device 102) for displaying video images. In other embodiments, the audio/video system 412 may couple to an amplifier and/or speakers located elsewhere in the venue 402 external to the entertainment system 100. A media player application 403 (such as, e.g. the Windows Media Player by the Microsoft Corporation of Redmond, Wash.) is provided for causing the audio/video system 412 to perform the requested entertainment content. For example, when the requested entertainment content comprises a song, the media player application 403 will retrieve from the file system 404 the digital file containing audio data (e.g., encoded using WMA or MP3 compression algorithms) corresponding to the requested song. The media player application 403 will process the digital file to produce an analog audio signal that can be played over loudspeakers located either within the entertainment system 100 or elsewhere in the venue.

A payment interface 411 may be provided for receiving the payment from users in exchange for providing the entertainment services. As shown in FIG. 1, the payment is received as cash payment in the coin collector 106 or the bill collector 112, or as non-cash payment into the card reader 108. When non-cash payment is received, the payment interface 411 may retrieve payment authorization from the financial services provider associated with that debit or credit card, a smart card reader, any combination of the above, or any other payment receiving mechanism.

A network interface 407 provides an interface between the entertainment system 100 and the network 202 and may comprise, e.g., an RJ-11 port, a wireless adapter, or a modem. An operational database 406 for storing various configuration setting values and information about the entertainment content is also provided.

An external display interface 408 provides an interface between the entertainment system 100 and the external video display device 150. In some embodiments, the primary entertainment device 101 includes a graphics rendering device, such as a graphics processing unit (GPU), which generates the video signals for display on the external video display device 150. Such configurations are commonly used with conventional personal computers with dual monitor support.

In other embodiments, the external video display device may comprise a separate video control device (e.g., a personal computer) with a dedicated monitor and its own media player application. In these embodiments, the primary entertainment device 101 may transmit the images and/or audio for presentation using a variety of methods. For example, the primary entertainment device 101 and the external video display device may both include network interfaces and may communicate with each other over a local-area network (LAN) in the venue location. The primary entertainment device 101 may communicate with the external video display device to instruct the external video display device to schedule or present entertainment content and other messages, as will be described in further detail below.

Finally, a control module 410 is provided for managing the various functions of the entertainment system 100. The control module 410 may comprise multiple modules for managing the various features of the entertainment system 100. These modules may include, for example, a money handler 421 for managing monetary payment from users, a credit manager 422 for managing the consumption of credits, a content performance queue 423 for managing the performance of entertainment content selected by users, and a message manager 424 for managing message content provided by the entertainment system 100, as will be described in greater detail below. The entertainment system 100 may be implemented using, for example, standard personal computer hardware and architecture.

The embodiment shown in FIG. 4 can operate as follows. The entertainment system 100 includes a local file system 404 storing a plurality of different entertainment content files available to users. These users can utilize the user interface 401 and payment interface 411 to select and pay for the performance of entertainment content. The user may pay for the performance by inserting cash into one of the cash payment collectors 106, 112. If the user attempts to pay for the performance using, e.g., a credit card or ATM card, the entertainment system 100 can connect to a payment authorization server on the network 202 in order to authorize the payment. In some embodiments, the user need not pay for the performance of entertainment content. This service may be paid for by the venue proprietor, or may be paid for through advertising campaigns displayed by the entertainment system 100. The control module 410 maintains a queue of requested entertainment content and will instruct the media player application 403 to play each requested entertainment content in turn from the queue or according to some other prioritization scheme.

The control module 410 may also store a history of events that take place on the entertainment system 100. These events can include, e.g., entertainment content performed, revenue collected, advertising events, and local messaging events. For example, each time a song is played, that performance is recorded. The total performances of songs (and/or other types of entertainment content) by the entertainment system 100 is reported to the host system 210. This reporting may be required in order to satisfy royalty and/or licensing requirements for the entertainment content. The amount of revenue collected may be stored and reported back to the host system 210 so that the actual cash collections may be compared to the reported collections.

In order to communicate the event history from the entertainment system 100 to the host system 210, the control module 410 transmits messages to the message server 222 of the host system 210 via the network 202 containing information regarding the events. Each message may comprise, e.g., an XML message, and may include information such as, e.g., a Location ID uniquely identifying the venue where the content was performed, a Device ID uniquely identifying the device or disk drive that was used, the local time of the performance at the location, a Content ID uniquely identifying the performed entertainment content, an indication of whether the entertainment content was performed by request or by automatic playback, and the price paid for the performance. These messages may be sent each time an event occurs (e.g., each time an entertainment content item is requested or performed), or may be sent periodically including information regarding a plurality of events. The host system 210 receives the message from the entertainment system 100 and stores the historical performance records. The host system 210 can then retrieve aggregate performance data regarding all of the entertainment systems 100 on the network and specific performance data on the entertainment content being requested at each system 100.

The control module 410 may periodically contact the message server 222 of the host system 210 to request a manifest of files that the entertainment system 100 should have locally stored in order to possess a full complement of software and other files. This manifest may be delivered from the host system 210 to the entertainment system 100 as an XML document. If any files listed in the manifest are new or modified since the last time the control module 410 loaded its software, a content manager component of the control module 410 may request those files from the host system 210 in a process similar to the acquisition of new entertainment content. Once all of the files identified by the manifest have been acquired, at a predetermined time (or within a predetermined window of time), the files will be applied and the entertainment system 100 will reboot. The files listed on the manifest may include music catalogs, attract loops, and advertising content.

As described above, the operational database 406 may store various configuration settings for controlling the operation of the entertainment system 100. Each configuration value stored in the operational database 406 may both centrally manageable (e.g., from the host system 210) or locally manageable (e.g., by an administrator interacting with the GUI interface of the entertainment system 100).

### Local Messages (Spot Advertising)

In accordance with embodiments of the present invention, the entertainment system may be configured to perform local messages, which the user may purchase or request to occupy the locations in the user interface of the entertainment devices that are available to advertising content.

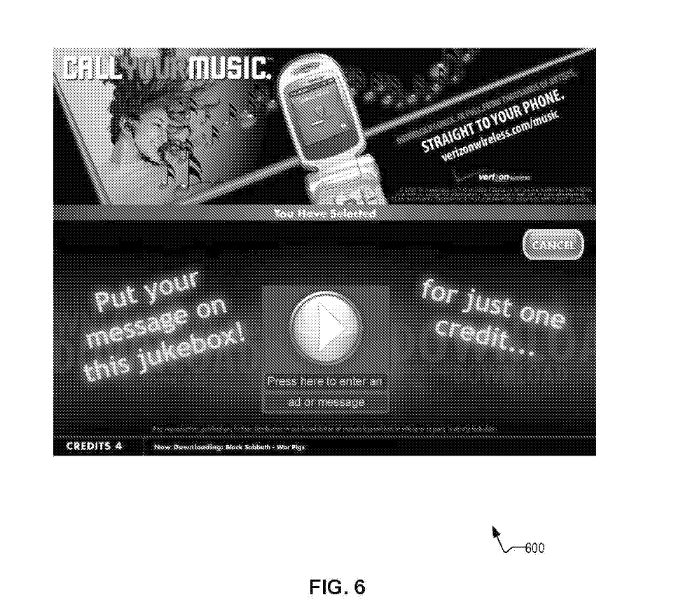

FIG. 5 is a flowchart 500 of a method of operating an entertainment system. In step 501, a request to perform an entertainment content item is received. In step 502, the requested entertainment content item is performed. In step 503, a request to perform a local message is received. In step 504, a series of messages a performed, including commercial advertisements and the requested local message.

As described above, in some embodiments, the entertainment system 100 utilizes the display device 102 and/or the audio system for commercial advertising purposes. The entertainment system 100 is configured to receive one or more commercial advertisements from the host system 210 for performance. These commercial advertisements may take various forms. For example, the commercial advertisements may comprise audio and video promoting a product or service, similar to conventional commercials shown during television broadcasts. In other cases, the advertisements may be static images or rich media advertisements. Rich media advertisements are graphical advertisements enhanced by motion, sound, video, and/or an interactive element. The rich media advertisements may utilize video, audio, vector graphics (e.g., the Flash programming platform by Adobe Systems, Inc., of San Jose, Calif.), DHTML, Shockwave, and Java, and may integrate video and/or audio with interactivity. Systems and methods for distributing and performing advertising content are described in U.S. patent application Ser. No. 11/262,108, filed Oct. 27, 2005, entitled “Distribution of Advertising Content for an Entertainment Device”, the disclosure of which is incorporated by reference in its entirety.

The operator of the host system 210 may sell advertisements to various businesses for performance on the entertainment systems 100 of the entertainment network 200. The cost of these advertisements may be determined by a variety of factors, such as, e.g., the length of the advertisement, the number, type, and location of the entertainment systems on which the advertisements are to be performed, and number of times that the advertisements are performed on the entertainment systems. For example, an advertiser may purchase a 15 second advertisement at the bulk rate of $10 per thousand impressions, which results in a cost per impression (“CPM” or “Cost Per Mille”) of 1 cent per advertisement.

For example, a first advertiser may purchase a 15-second Flash-based advertisement to be performed at all bars in the San Francisco Bay Area. A second advertiser may purchase a 15-second advertisement to be performed at all bars across the country. Several other advertisers may also pay for the performance of advertisements based on, e.g., geographic location and venue type of the entertainment system. Each entertainment system may then be provided with a block of commercial advertisements that are to be performed repeatedly throughout the day. Alternatively, each entertainment system may refer back to the host system in “real-time” for instructions each time the entertainment system is ready to perform a commercial advertisement. The content of the advertisement may have been transmitted to the entertainment system far in advance of the time of performance, the content may be transmitted immediately before performance, or the content may be streamed to the entertainment device during performance. These commercial advertisements may be performed in various ways. For example, they may be played constantly throughout the day when the video display device is not otherwise being used (e.g., for displaying a music video purchased by a user). Alternatively, the advertisements may only be played when a requested song is being performed by the entertainment device or only during certain periods of the day.

The message manager 424 may be used to manage the performance of these commercial advertisements. The message manager 424 may create an advertising lineup which controls the sequence of advertisement performance. For example, the advertising lineup may indicate that the advertisements should be performed in the following order: Advertisement #1, Advertisement #2, Advertisement #3, Advertisement #1, Advertisement #4, and Advertisement #5. Then, after this sequence is completed, the advertising lineup will be repeated. Alternatively, the message manager 424 may refer to the host system for instructions each time the message manager 424 is ready to perform an advertisement. Alternatively, other combinations and variations on generating the advertising lineup may be used. In another example, the message manager 424 may control only local messages (e.g., “spot ads”) entered by users, as described in greater detail below. The message manager 424 will then refer to the host system for all other advertising content that is part of larger regional or national advertising campaigns.

The display device 102 provides a graphical user interface to enable users to browse and/or search for entertainment content and to select an entertainment content item for performance on the entertainment system 100. The browsing interface may be configured to allow users to scroll through lists of albums by genre, popularity, release date, etc. The searching interface may be configured to allow users to search for entertainment content by entering text corresponding to a song title, an album title, and/or an artist name. In some embodiments, the selection mode may be configured to allow users to browse and/or search for entertainment content locally stored in the file system 404 of the entertainment system 100 and entertainment content remotely stored and available for retrieval from the host system 210.

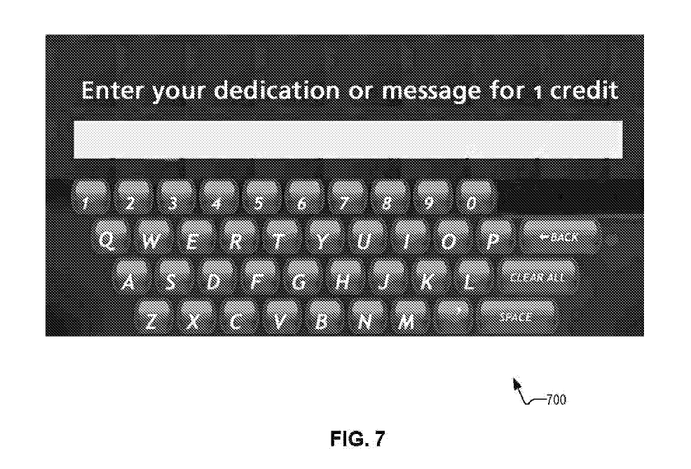

The graphical user interface may also provide users with an option to request that a local message be performed. In some embodiments, the user may be prompted to request performance of a local message after an entertainment content item has been selected by the user. For example, if the user has selected a particular song to be performed, the user may then receive a prompt inquiring whether the user would like to dedicate the song to someone else in the venue. In other embodiments, the user may purchase the local message without first requesting performance of entertainment content. FIG. 6 shows a sample screenshot 600 of a prompt to a user to request performance of a local message.

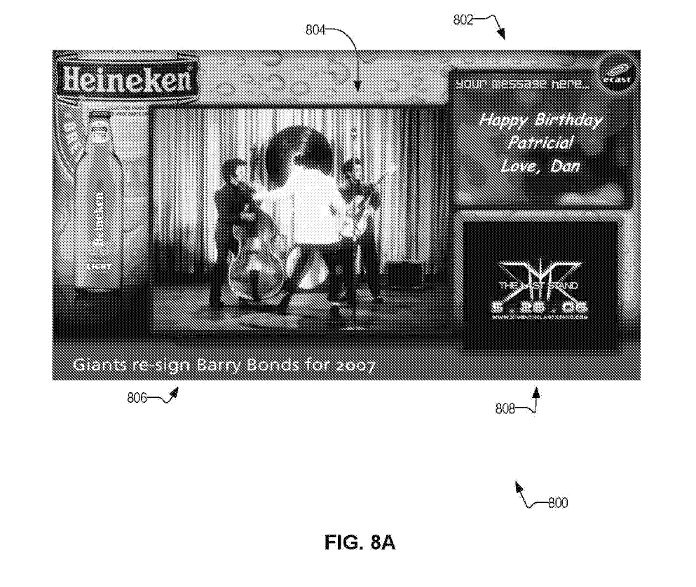

If the user would like to request the performance of a local message, the user may be prompted to select from a variety of options. For example, the user may select one of a plurality of predefined messages (e.g., “Happy Birthday”, “I Love You”, “Congratulations”, or “This One's For You”). Alternatively, the user may select one of plurality of customizable messages which allow the user to enter text to be included into the local message using a keyboard on the touch screen graphical user interface. For example, the user may enter the name of a friend in the venue, and the friend's name would be inserted into a message, such as, e.g., “Happy Birthday, (name)”, “I Love You, (name)”, “Congratulations, (name)”, or “This One Goes Out To (name)”. In yet other embodiments, the user may utilize the keyboard to type a fully customizable message (e.g., “Go 49ers!”). In yet other embodiments, the user may select from one or more templates that can be customized by the user to create the local message. FIG. 7 shows an exemplary touch screen interface 700 that may be used to enable a user to enter the local message.

As described above, the entertainment system 100 may be used to perform commercial advertisements. A common feature of commercial advertisements is that they are purchased for performance at multiple venues. In contrast, the local messages are purchased for performance at a single venue. Typically, the content of the commercial advertisements are provided to the host system 210 and then distributed to multiple entertainment systems 100 across the network 200 for performance. In contrast, the local messages are typically provided to a particular entertainment system 100 by a user physically located in the same venue as that entertainment system 100. Each local message is performed locally at a single venue. Thus, the bulk-purchased commercial advertisements may be considered to be network messages since they are performed at multiple venues across the network, while the local messages are performed at a single venue.

The local messages and network messages (e.g., commercial advertisements) may be displayed using the external video display device 150, when such a display device is available. This enables the messages to be continuously displayed, even when users are utilizing the primary display device 102 for selecting entertainment content to be performed. In addition, the primary display device 102 is generally of a limited size (due to physical constraints of the entertainment device housing 110 and the increased cost of a touch screen display device over a conventional display device) and is positioned at or below the typical user's eye level in order to facilitate comfortable interaction with the user. Therefore, any messages (including both commercial advertisements and local messages) may not easily be seen throughout the venue if they are displayed on the primary display device 102. Because the external video display device 150 is not used as a touch screen interface, it is more commercially feasible that the external display device 150 comprise a much larger screen (e.g., a 42″ flat panel monitor) which can be mounted high above eye level (e.g., 5′, 6′, 7′, or 8′ above the floor of the venue), thereby making it visible to more people in the venue. In some cases, the external display device may comprise a video projector which projects a video image onto a wall or screen. In this case, the projected image may be located high above eye level.

If the entertainment system does not include an external display device 150, the messages (both local and network) may be performed using the primary display device 102. In some cases, a portion of the screen may be used to display the local message, similar to a banner advertisement used in conventional web sites. This enables the remainder of the screen to be utilized by other users wishing to browse the entertainment content catalog.

After the local message is requested, the message manager 424 will insert the local message into a series of messages currently in queue for performance. Typically, the series of messages will include only the commercial advertisements that had previously been purchased by advertisers. However, when a local message is requested by a user, the local message may be given priority over the commercial advertisements. For example, any commercial advertisement currently being performed may be immediately interrupted and replaced with the local message.

If the advertisement is interrupted, then this interrupted performance would not be counted as a full impression in calculating the advertising charge to the advertiser. Alternatively, the currently performed advertisement may be allowed to complete before the local message is displayed. Then, instead of performing the next advertisement in queue, the local message would be performed.

In some cases, the local message would replace one or more of the advertisements in the advertising lineup. In other cases, the local message would be inserted into the advertising lineup, and after performance of the local message, the sequence of commercial advertisements would continue.

The length of performance of the local message may vary. The local message may have a predetermined length (e.g., 12 or 15 seconds) and be performed once. In other embodiments, the local message may continuously be performed for the entire time that the user's requested entertainment content item is being performed. In yet other embodiments, the local message may have a predetermined length, but will maintain its position in the advertising lineup until the requested entertainment content item has completed its performance. Thus, each time the advertising lineup repeats during the course of the requested song, the local message would again be performed. After the requested song has been completed, the local message would be removed from the advertising lineup.

If the user's entertainment content item cannot be played immediately after its request (such as if there are several songs already in the content performance queue), the performance of the local message may be delayed until the user's requested entertainment content item is performed.

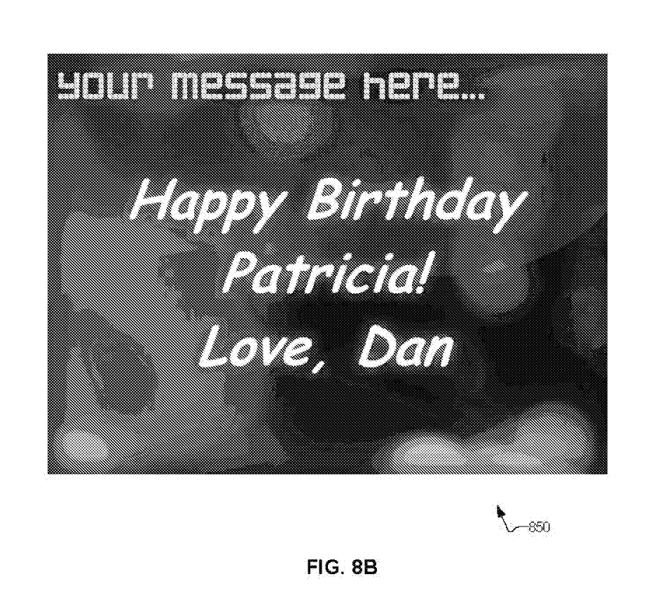

FIG. 8A shows an exemplary screenshot 800 of the performance of a local message. In this embodiment, which may be suitable for an external video display device, the video display device simultaneously displays multiple types of content. A first portion 802 of the video display area is used for displaying all messages, including commercial advertisements and local messages (e.g., “Happy Birthday Patricia! Love, Dan”). A second portion 804 may be used to display a video stream corresponding to an item of requested entertainment content. A third portion 806 may be used to display a text-based message, such as a news “ticker”. In some cases, a fourth portion 808 may be used to display a commercial advertisement simultaneously with the local message.

FIG. 8B shows another exemplary screenshot 850 of the performance of a local message. In this case, the local message is the only content being displayed. This embodiment may be utilized, e.g., when the screen size for the display device is small or to draw more attention to the local message without the distractions of additional content, as in FIG. 8A.

In some embodiments, the local message may include other components provided by the user. For example, the user may provide a digital file, such as an image, video, or audio file, to be displayed as part of the local message. This file may be provided to the entertainment system 100 from another device on a personal area network (e.g., PAN 130) with the entertainment system 100. Accordingly, a user with a personal mobile computing or communication device 132 (e.g., a laptop, palmtop, personal digital assistant (PDA), or mobile telephone) may connect to the entertainment system 100 via PAN 130 using, e.g., a wired or wireless communication technology, such as USB, FireWire, IrDA, or Bluetooth. The user may then transmit the file to the entertainment system 100 for performance with the local message.

In some embodiments, the user may direct the entertainment system 100 to retrieve the file via the network 202. For example, the user may identify an account on a web site (e.g., a photo sharing or blog web site) from which the file may be retrieved. In yet other embodiments, the user may transmit text, graphical image, or video via electronic mail for performance as a local message. This may be accomplished, e.g., by providing the user with a unique email address after the user has purchased the local message. The user may then transmit an email message to that unique email address for performance.

In yet other embodiments, the user may provide the content of the local message via a telecommunications network. For example, the user may utilize a mobile phone or e-mail device to send a text message to the entertainment device 100. The content of this message may then be included in the local message.

The commercial advertisements performed by the entertainment systems may come from a variety of different sources. In some cases, the commercial advertisement may be pre-ordered by an advertiser in advance of the expected performance time (e.g., more than one day in advance). In some cases, the commercial advertisement may be ordered and the content of the advertisement provided by an advertiser located outside of the venue. In some cases, the commercial advertisement content is transmitted first to the host system 210, which then distributes the advertisement content to one or more entertainment systems 100 on the entertainment network 200. In some cases, the advertiser will make a single purchase for the performance of large numbers of commercial advertisements, e.g., greater than 100 performances (sometimes referred to as “impressions”), greater than 1000 performances, or more. In some cases, the advertiser will make a single purchase for the performance of commercial advertisements to be performed on more than one entertainment system. In some cases, the cost per performance of the commercial advertisements considerably less than the cost of the performance of a single local message. For example, the cost of a local message may be several times more the cost of a commercial advertisement, or may be one or more orders of magnitude more expensive (e.g., the cost of a local message may be $1.00, while the cost per impression of a commercial advertisement may be a few cents). Any one or more of the purchase scenarios described above may distinguish the commercial advertisements from the local messages described herein.

### Payment

In some cases, the user may be required to pay for the performance of the local message. Because the revenue generated for each commercial advertisement is generally very minimal (e.g., on the order of a few cents), payment for local messages which are performed in place of commercial advertisements can generate far more revenue than the advertising. The charge may be, e.g., 25 cents, 50 cents, one dollar, or more, for each local message. This payment may be provided in a variety of ways. For example, the user may utilize the payment interface 105 to purchase credits which the user may apply towards the performance of both the entertainment content (e.g., a song) and the local message (e.g., the song dedication).

In yet other embodiments, the user may be associated with a user account maintained by the host system 210 or the entertainment device 100. The user account may include identity information (e.g., username, full name, mailing address, e-mail address, etc.) and may be associated with an external payment source. The external payment source may comprise a link to a credit card account, a bank account, a mobile phone account, or the like, against which the cost for the services may be charged by the host system 210. Alternatively, the external payment source may comprise a stored value account including credits that had been accrued by the user. The stored value account may include prepaid credits purchased from the user, or credits granted to the user in exchange for other activity (such as the creation of the user account or the completion of online surveys). In other embodiments, the user may use “usage credits” in exchange for performance of the local message. The user may obtain these usage credits by participating in some type of desired activity, and these usage credits may be associated with a user account and accumulated over time. For example, a user may have a user account on the entertainment network and may receive usage credits for providing personal information to the entertainment network or for logging into the user account each time the user purchases the performance of entertainment content.

The user may be required to sign into the user account before being able to request the performance of the local message. The user would then pay for the performance of the local message and/or the entertainment content using the external payment source associated with that user account. An advantage of requiring such a sign-in is that the payment for the local messages would not consume cash from the user's pocket. This may be desirable for the venue owner, who would generally prefer that the user spend his or her available cash on the other goods and services provided at the venue. This is because the money spent on the venue's goods and services goes directly to the owner, whereas the payments for local messages may have to be shared with other parties responsible for the operation of the entertainment device 100. The use of the external payment source provides an opportunity for both the venue owner and the entertainment system operator to increase revenue, while providing the user with an improved entertainment experience that can be conveniently purchased.

In accordance with embodiments of the present invention, systems and methods are provided for distributing revenue received for the performance of local messages. In many cases, there are three parties involved with the operation of each entertainment system 100. First, there is the venue owner, who allows the entertainment system to be installed in the venue. Second, there is the service provider, which manages the host system 210 and negotiates the purchase of advertising campaigns with the advertisers. Third, there is the operator of the entertainment system, who purchases the hardware for the entertainment system and negotiates with the venue owner to install the entertainment system in the venue. In some cases, there may be only two parties involved, as the venue owner may also be the operator of the entertainment system.

The revenue received by the entertainment system from users in exchange for performance of entertainment content is typically divided between the service provider and the other parties involved with the operation of the entertainment system 100, such as the venue owner and/or the operator of the entertainment system. The number of parties sharing in the revenue and the revenue allocation to each party may vary. In one example, the service provider receives 20% of the total revenue, and the remaining 80% of the revenue is provided to the other party or parties. The cash payments received by the entertainment system are typically collected by the device operator. In addition, the entertainment system stores a record of payments received from users and reports these payments to the service provider. The service provider may then calculate the amount of money that should be provided to the various parties according to a predetermined agreement regarding how the revenue is to be allocated amongst the parties. The service provider can then provide a report to the venue owner and/or the device operator indicating the amounts that should be paid to each.

When additional revenue is generated from the local message requests by users, it may be desirable to provide a mechanism for determining how that payment is allocated between the three parties. In some cases, the allocation of revenue from advertisements and local messages may differ from the allocation of revenue from the performance of entertainment content. In this case, the service provider is wholly responsible for marketing to advertisers, and may therefore be considered to be entitled to a greater share of the network-wide advertising revenue. Similarly, because the local messages displace the revenue generated by network-wide advertising, the service provider may also be entitled to a greater share of the local message revenue.

Thus, the message manager 424 of the entertainment system 100 may be further configured to store and report to the revenue module 224 of the host system 210 sufficient information for calculating the revenue generated by the local messages. This information may include, e.g., a count of the local messages requested or a revenue amount generated by local message requests. The revenue module 224 may then calculate the amount of revenue that should be allocated to each of the parties, based on the existing allocation agreement regarding the local message revenue. This amount can then be reported to the device operator and the venue owner. If the payment for the local messages is provided via credit card transactions or via stored value accounts managed by the service provider, then the service provider would have already received the payment for the local messages and would then pay the device operator the appropriate amount due.

Similarly, the message manager 424 may report to the revenue module 224 information regarding the performance of commercial advertisements. The revenue generated based on the commercial advertisements can also be allocated and paid to the device operator and venue owner.

Embodiments of the present invention may provide various advantages not provided by prior art systems. The performance of local messages can provide an improved experience for the users, while increasing revenue for the venue owner, device owner/operator, and network/service provider. The use of user accounts with separate payment sources can improve the convenience to the user while minimizing any negative perception about lost or diverted revenue on the part of the device owner/operators and venue owners.

While the invention has been described in terms of particular embodiments and illustrative figures, those of ordinary skill in the art will recognize that the invention is not limited to the embodiments or figures described. In particular, the types of local messages that may be requested by the user may vary and need not take the form specifically described and illustrated herein. A local message need not be limited to just social messages from one person to another identified person (e.g., as is the case with a message such as “Happy Birthday, John”. Instead, the local message may be of a commercial nature, but intended for performance at a single venue only. For example, the local message may be requested by the owner of a business located close to the venue in which the entertainment system is located. This message may be used to advertise the goods or services provided at the nearby business (e.g., “20% off everything for people who mention this ad!”). The commercial message is still considered to be a local message because it is requested for performance at a single venue.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

I/We claim:

1. A method comprising allowing a user to request performance of a local message on a jukebox, the local message being associated with entertainment content selected for play on the jukebox.
